(19) United States
(12) Patent Application Publication
(10) Pub. No.: US 2013/0225243 A1
(43) Pub. Date: Aug. 29, 2013

(54) APPARATUS FOR REAL TIME ENCODING OF MOBILE DEVICE SCREEN AND METHOD THEREOF

(71) Applicant: ELECTRONICS AND TELECOMMUNICATIONS RESEARCH INSTITUTE, (US)

(72) Inventors: Mi Ryong PARK, Gyeonggi-do (KR); Hyun-Woo OH, Daejeon (KR); Jong Hyun JANG, Daejeon (KR); Kwang Roh PARK, Daejeon (KR); Deockgu JEE, Daejeon (KR); Ji Yeon KIM, Daejeon (KR)

(73) Assignee: ELECTRONICS AND TELECOMMUNICATIONS RESEARCH INSTITUTE, Daejeon (KR)

(21) Appl. No.: 13/753,639

(22) Filed: Jan. 30, 2013

(30) Foreign Application Priority Data
Feb. 23, 2012 (KR) 10-2012-0018569

(51) Int. Cl. H04M 1/02

(52) U.S. Cl. CPC H04M 1/0266
USPC 455/566

(57) ABSTRACT

Disclosed are an apparatus of real time encoding of a mobile device screen and a method thereof. In accordance with embodiments of the present invention, the real time encoding and storing of the mobile device screen can be performed by using a hardware video codec embedded in the mobile device, thereby realizing the high-performance encoding without degrading the image quality while reducing load sharing of a CPU under multitask environment and the video codec can be selectively used according to the application operation, thereby improving the use of the video codec.

### CROSS-REFERENCES TO RELATED APPLICATIONS

The present application claims priority under 35 U.S.C 119(a) to Korean Application No. 10-2012-0018569, filed on Feb. 23, 2012, in the Korean Intellectual Property Office, which is incorporated herein by reference in its entirety set forth in full.

### BACKGROUND

Exemplary embodiments of the present invention relate to an apparatus for real time encoding of a mobile device screen and a method thereof, and more particularly, to an apparatus for real time encoding and storing of a mobile device screen and a method thereof capable of real time encoding of a mobile device screen in hardware.

Generally, a mobile device (for example: smart phones, mobile phones) is configured to record a current screen in software using a high-performance CPU and allow application programs to use the recorded screen.

However, the method for recording and encoding a mobile device screen in software as described above has restricted processing performance even when a wide VGA (WVGA) video is processed and thus, image quality may be remarkably degraded or the number of frames that can be reproduced per second may be limited.

In addition, the method for recording and encoding the mobile device screen in software puts a great burden on a CPU for processing the screen. Therefore, in the case of the smart phones operated under a multitask environment on an operating system, the method may severely affect an operation of various applications (or apps) simultaneously performed.

As the related art, KR Patent Laid-Open No. 2006-0002602 (Publication in Jan. 9, 2006: A Method And An Apparatus Of Transmitting Alternated Video Signal For Mobile Phone)

The above-mentioned technical configuration is a background art for helping understanding of the present invention and does not mean related arts well known in a technical field to which the present invention pertains.

### SUMMARY

An embodiment of the present invention is directed to an apparatus for real time encoding of a mobile device screen and a method thereof capable of real time encoding and storing of a mobile device screen in hardware.

Further, an embodiment of the present invention is directed to an apparatus for real time encoding of a mobile device screen and a method thereof capable of real time encoding and storing a screen using a hardware video codec embedded a mobile device.

Further, an embodiment of the present invention is directed to an apparatus for real time encoding of a mobile device screen and a method thereof capable of selectively using a hardware video codec embedded in a mobile device according to an application operation.

An embodiment of the present invention relates to an apparatus for real time encoding of a mobile device screen, including: a video format conversion unit configured to convert a first screen video signal to be output to a display unit into a second screen video signal of a preset video format; a switching unit configured to receive the second screen video signal converted by the video format conversion unit and a camera video signal photographed by a camera and selectively output one of the received signals; and an application processor configured to real time encode the second screen video signal or the camera video signal output from the switching unit in hardware.

The first screen video signal is a video signal that is of a format according to a specification of the display unit.

The video format may be the same format as the camera video signal.

The video format may be a format that can be encoded by a hardware codec unit included in the application processor.

The switching unit may output the second screen video signal or the camera video signal according to a selection signal input from the application processor.

An embodiment of the present invention relates to a method for real time encoding of a mobile device screen, including: selectively inputting, by an application processor, any one of a second screen video signal generated by converting a first screen video signal to be output to a display unit into a preset video format and a camera video signal photographed by a camera from a switching unit; and real time encoding, by the application processor, the second screen video signal or the camera video signal in hardware.

The first screen video signal may be a video signal that is of a format according to a specification of the display unit.

The video format may be the same format as the camera video signal.

The video format may be a format that can be encoded by a hardware codec unit included in the application processor.

In the selectively inputting, by an application processor, any one of the second screen video signal and the camera video signal from the switching unit, the switching unit may output the second screen video signal or the camera video signal according to a selection signal input from the application processor.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagrams of an apparatus for real time encoding of a mobile device screen in accordance with an embodiment of the present invention;

FIG. 2 is a diagram illustrating in more detail of a configuration of an application processor in an apparatus for real time encoding of a mobile device screen in accordance with an embodiment of the present invention; and

FIG. 3 is a flow chart illustrating an operation of a method for real time encoding of a mobile device screen in accordance with an embodiment of the present invention.

### DESCRIPTION OF SPECIFIC EMBODIMENTS

Hereinafter, an apparatus for real time encoding of a mobile device screen and a method thereof in accordance with an embodiment of the present invention will be described with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

An embodiment of the present invention may real time encode and store a mobile device screen in hardware using a hardware (HW) video codec included in an application processor (AP) of a mobile device (for example: smart phone).

Further, the embodiment of the present invention may selectively use the HW video codec included in the AP of the mobile device (for example; smart phone) for encoding of a camera input video or the mobile device screen, thereby reducing load sharing and reducing an effect on an operation of other applications.

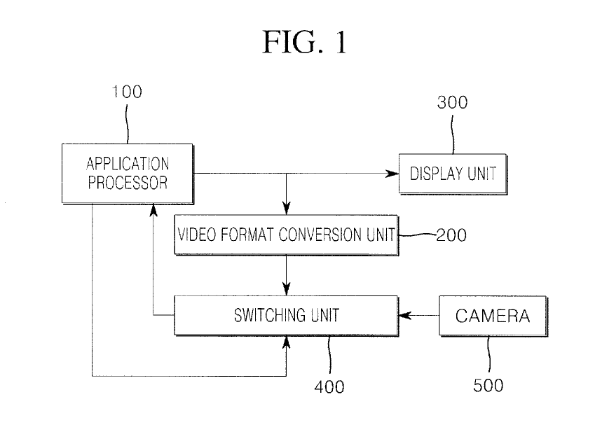

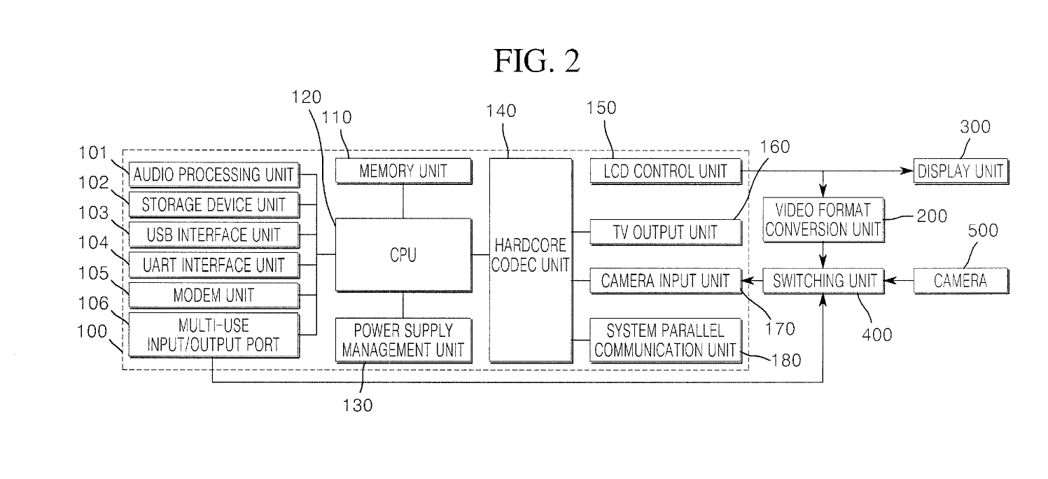

FIG. 1 is a block diagrams of an apparatus for real time encoding of a mobile device screen in accordance with an embodiment of the present invention and FIG. 2 is a diagram illustrating in more detail of a configuration of an application processor in an apparatus for real time encoding of a mobile device screen in accordance with an embodiment of the present invention.

As illustrated in FIG. 1, an apparatus for real time encoding of a mobile device screen in accordance with an embodiment of the present invention includes an application processor 100, a video format conversion unit 200, a display unit 300, a switching unit 400, and a camera 500.

The application processor 100, which is a core controlling an overall operation of a mobile device (for example; smart phone), includes a plurality of general purpose input/output ports (GPIOs) 106 for connecting various external apparatuses.

The general purpose input/output port (GPIO) 106 is generally used to connect to the external apparatuses or control input/output, and transmit and receive input/output data.

The application processor 100 inputs a selection signal to the switching unit 400 through the general purpose input/output port (GPIO) and encodes a screen video signal or a camera video signal input from the switching unit 400 in hardware.

The video format conversion unit 200 receives the screen video signal to be output to the display unit 300 from the application processor 100 and converts the received screen video signal into a preset video format, which is in turn provided to the switching unit 400.

The switching unit 400 selectively outputs any one of the converted screen video signal input from the video signal format unit 200 and the camera video signal input from the camera 500 and provides the output signal to the application processor 100.

The switching unit 400 may be configured of a multiplexer (MUX).

In addition, the switching unit 400 may selectively output any one of the screen video signal and the camera video signal according to the selection signal that is input through the general input/output port (GPIO) from the application processor 100.

For example, the switching unit 400 may output the camera video signal to the application processor 100 when the selection signal input through the general purpose input/output port (GPIO) is ‘0’ and may output the screen video signal to the application processor 100 when the selection signal input through the general purpose input/output port (GPIO) is ‘1’ (enable signal).

That is, the application processor 100 controls the switching unit 400 to selectively receive the screen video signal or the camera video signal and encode the received signal in hardware.

Meanwhile, the screen video signal to be output to the display unit 300 from the application processor 100 is output as a format meeting a specification (for example; resolution) of the display unit 300.

In this case, a format of the screen video signal to be output to the display unit 300 may be different from a format of the camera video signal input from the camera 500.

Therefore, the video format conversion unit 200 receives the screen video signal to be output to the display unit 300 from the application processor 100 and converts the received screen video signal into the same format as the camera video signal, which is in turn provided to the switching unit 400.

Since a hardware codec unit 140 included in the application processor 100 is generally configured to process the camera video signal, the video format conversion unit 200 converts the screen video signal into a format that may be processed by the hardware codec unit 140 of the application processor 100 and provides the converted screen video signal.

As described above, in accordance with the embodiment of the present invention, the screen video signal converted into the preset video format (format that can be processed by the hardware codec unit 140) through the video format conversion unit 200 without affecting the output of the display unit 300 is loop-backed to the application processor 100 through the switching unit 400 and is encoded, thereby implementing the high-speed hardware encoding of the screen output to the display unit 300 only in the slight software processing.

Meanwhile, as illustrated in FIG. 2, the application processor 100 used for the mobile device includes the CPU core 120, thereby operating various application programs (apps).

In addition, the application processor 100 includes a memory unit 110 and a power supply management unit 130 and includes the hardware codec unit 140 that serves to perform a hardware (HW) video codec for high-speed video processing, a 3D engine, and a graphic accelerator function.

Further, the application processor 100 includes an audio processing unit 101 for audio processing, a storage device unit 102 for connecting external storage devices, an USB interface unit 103 for connecting a universal serial bus (USB), an UART interface unit 104 for connection of RS-232C, serial, and the like, a modem unit 105 for communication modulation/demodulation processing, and the general purpose input/output port (GPIO) 106 for connecting various external apparatuses.

In addition, the application processor 100 includes an LCD control unit 150 for processing the output of the screen video signal, a TV output unit 160 for outputting and displaying a partial screen of the mobile device to TV or other media, a camera input unit 170 capable of receiving the camera video signal, and a system parallel communication unit 180.

In this case, the screen video signal output from the LCD control unit 150 of the application processor 100 is output to the display unit 300 and is input to the video format conversion unit 200 and is converted into the screen video signal of the video format (for example; size, resolution) preset by the video format conversion unit 200 and is provided to the switching unit 400.

The switching unit 400 selectively outputs one of the screen video signal input from the video format conversion unit 200 and the camera video signal input from the camera according to the selection signal input through the general input/output port (GPIO) from the application processor 100 and provides the output signal to the application processor 100.

In detail, the screen video signal or the camera video signal that is selected and output by the switching unit 400 is input to the camera input unit 170 of the application processor 100.

Thereafter, the screen video signal or the camera video signal input to the camera input unit 170 is encoded by the hardware codec unit 140 and is stored in the memory unit 110 through the CPU 120.

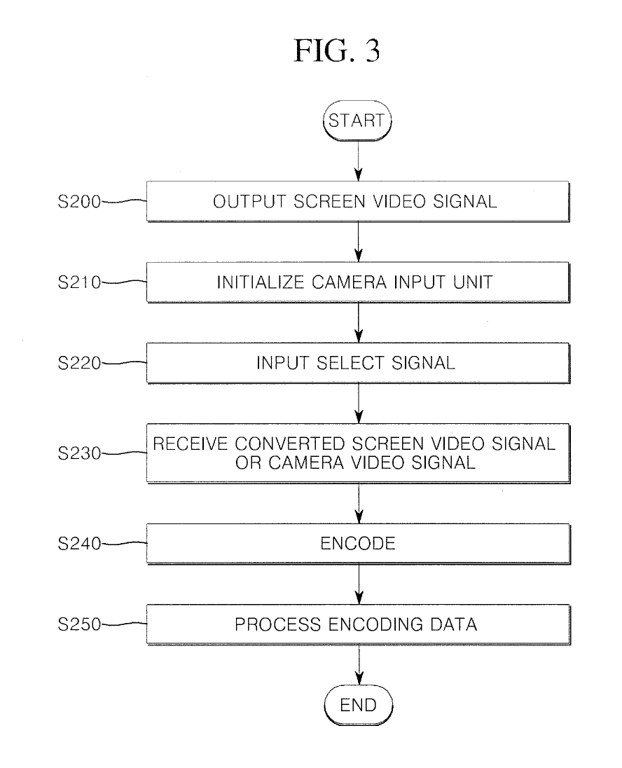

FIG. 3 is a flow chart illustrating an operation of a method for real time encoding of a mobile device screen in accordance with an embodiment of the present invention. The detailed operation of the present invention will be described with reference to FIG. 3.

First, the CPU 120 of the application processor 100 controls the LCD control unit 150 to output the screen video signal (S200).

Thereafter, the CPU 120 of the application processor 100 initializes the camera input unit 170 to set the camera input unit 170 in an input standby state (S210).

Thereafter, the CPU 120 of the application processor 100 inputs the selection signal to the switching unit 400 through the general purpose input/output port (GPIO) 106 (S220) and receives the screen video signal or the camera video signal output from the switching unit 400 according to the selection signal (S230).

When the selection signal is an enable signal, the switching unit 400 may output the screen video signal converted by the video format conversion unit 200 and provide the output screen video signal to the application processor 100.

In this case, the screen video signal output from the switching unit 400 corresponds to the screen video signal converted into the preset video format by the video format conversion unit 200 and is the video signal of the format that may be processed by the hardware codec unit 140.

The hardware codec unit 140 is generally a device for processing the camera video signal and the format of the screen video signal input to the application processor 100 is the same as the format of the camera video signal.

On the other hand, when the selection signal is not an enable signal, the switching unit 400 may output the camera video signal input from the camera 500 and provide the output camera video signal to the application processor 100.

Next, the application processor 100 controls the hardware codec unit 140 to perform the encoding on the screen video signal or the camera video signal (S240) and processes the encoded data in various types (S250).

As described above, according to the apparatus for real time encoding of a mobile device screen and the method thereof in accordance with the embodiment of the present invention, the real time encoding and storing of the mobile device screen can be performed using the hardware (HW) video codec embedded in the mobile device, thereby realizing the high-performance encoding without degrading the image quality while reducing the load sharing of the CPU 120 under the multitask environment.

In addition, in accordance with the embodiments of the present invention, the hardware video codec embedded in the mobile device can be selectively used according to the application operation, thereby improving the use of the video codec.

Although the embodiments of the present invention have been described in detail, they are only examples. It will be appreciated by those skilled in the art that various modifications and equivalent other embodiments are possible from the present invention. Therefore, the technical protection scope of the present invention should be defined by the appended claims.

In accordance with the embodiments of the present invention, the real time encoding and storing of the mobile device screen can be performed by using the hardware video codec embedded in the mobile device, thereby realizing the high-performance encoding without degrading the image quality while reducing the load sharing of the CPU under the multitask environment.

In addition, in accordance with the embodiments of the present invention, the hardware video codec embedded in the mobile device can be selectively used according to the application operation, thereby improving the use of the video codec.

Although the embodiments of the present invention have been described in detail, they are only examples. It will be appreciated by those skilled in the art that various modifications and equivalent other embodiments are possible from the present invention. Accordingly, the actual technical protection scope of the present invention must be determined by the spirit of the appended claims.

What is claimed is:

1. An apparatus for real time encoding of a mobile device screen, comprising:
a video format conversion unit configured to convert a first screen video signal to be output to a display unit into a second screen video signal of a preset video format;
a switching unit configured to receive the second screen video signal converted by the video format conversion unit and a camera video signal photographed by a camera and selectively output one of the received signals; and
an application processor configured to real time encode the second screen video signal or the camera video signal output from the switching unit in hardware.

2. The apparatus of claim 1, wherein the first screen video signal is a video signal that is of a format according to a specification of the display unit.

3. The apparatus of claim 1, wherein the video format is the same format as the camera video signal.

4. The apparatus of claim 1, wherein the video format is a format that can be encoded by a hardware codec unit included in the application processor.

5. The apparatus of claim 1, wherein the switching unit outputs the second screen video signal or the camera video signal according to a selection signal input from the application processor.

6. A method for real time encoding of a mobile device screen, comprising:
selectively inputting, by an application processor, any one of a second screen video signal generated by converting a first screen video signal to be output to a display unit into a preset video format and a camera video signal photographed by a camera from a switching unit; and
real time encoding, by the application processor, the second screen video signal or the camera video signal in hardware.

7. The method of claim 6, wherein the first screen video signal is a video signal that is of a format according to a specification of the display unit.

8. The method of claim 6, wherein the video format is the same format as the camera video signal.

9. The method of claim 6, wherein the video format is a format that can be encoded by a hardware codec unit included in the application processor.

10. The method of claim 6, wherein in the selectively inputting, by an application processor, any one of the second screen video signal and the camera video signal from the switching unit, the switching unit outputs the second screen video signal or the camera video signal according to a selection signal input from the application processor.
